(19) United States
(12) Patent Application Publication
(10) Pub. No.: US 2008/0056195 A1
(43) Pub. Date: Mar. 6, 2008

(54) Method for Base-Station Scanning of Mobile Terminal

(76) Inventors: Chang-Jae Lee, Chungcheongnam-Do (KR); Gi-Seon Ryu, Seoul (KR); Beom-Joon Kim, Seoul (KR)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 11/576,445

(22) PCT Filed: Oct. 1, 2005
(86) PCT No.: PCT/KR05/03259

§ 371 Date: Mar. 30, 2007

(30) Foreign Application Priority Data
Oct. 1, 2004 (KR) 1020040078324
Nov. 16, 2004 (KR) 1020040093675

(51) Int. Cl. H04Q 7/00

(52) U.S. Cl. 370/331

(57) ABSTRACT

In a case where the serving base station sets Scan Duration of the MOB-SCN-RSP message to 0 to reject a scan request from the mobile subscriber station as seen from above, the following two problems occur. First, because the mobile subscriber station does not know the reason why the scan request is denied, it may request scanning of neighbor base stations again by sending a scan request message to the serving base station before performing periodic ranging. In this case, the serving base station must reject again the scan request from the mobile subscriber station through a scanning response message, and thus an unnecessary exchange of a MAC message, and thus an unnecessary exchange of station and the serving base station. Such an unnecessary MAC message exchange becomes one of the causes of the waste of wireless resources and deteriorates the MAC processing efficiency. Second, when the serving base station intends to reject the scan request from the mobile subscriber station or stops the scanning of the mobile subscriber station during an Interleaving Interval of periodic scanning, a conventional scanning response message MOB-SCN-RSP has an inefficiency that all message parameters of about 5 bytes, including Scan Duration, Start Frame, Interleaving Interval, Scan iteration, Report Mode, Scan Period, etc. should be set to 0. When the mobile subscriber station requests for a neighbor base station scanning, if a scan duration includes a time point for performing periodic ranging of the mobile subscriber station, it is possible to avoid a periodic ranging operation of a mobile subscriber station from being obstructed by a scanning operation by allowing the mobile subscriber station to request for scanning again through a scan request message after performing a periodic ranging or to perform scanning. Moreover, in a case where the serving base station denies a scan request from the mobile subscriber station, it is possible to reduce it is possible to reduce the size of a scan request message and saving wireless resources by using a flag or scan duration parameter set to 0 representing the approval or denial of scanning instead of setting all scan parameters of a scan request message to 0.

### TECHNICAL FIELD

The present invention relates to a handover in a broadband wireless access system, and more particularly, to a method for neighbor base-station scanning for handover.

### BACKGROUND ART

A system of IEEE802.16e, whose international standardization for a broadband wireless access system is in progress, merely comprises a MSS (mobile subscriber station) serving as a terminal, a BS (base station) and an ASA (authentication service authorization) serving as an authentication management server, without having a hierarchical structure of a HLR (home location register), a VLR (visitor location register), a MSC (mobile switching center), a BSC (base station controller), a RNC (radio network controller) and so on, unlike existing second and third generation mobile communication systems. A common physical layer (PHY) and a medium access control (MAC) are defined between the base station and the terminal.

FIG. 1 shows an IEEE802.16e network structure and a handover procedure, in which a network structure provided in IEEe802.16e and handover operations on a data plane and a control plane are shown. A base station in charge of MSS communication is referred to as a serving BS.

Preprocessing procedures performed in a broadband wireless access system for handover of a MSS include a network topology advertisement procedure in which a base station broadcasts information related to neighbor base stations and reports them to the MSSs, a scanning (MSS scanning of neighbor BS) procedure for measuring the channel quality of the neighbor base stations based on the neighbor base station information, and an association procedure for optionally setting initial terminal power settings and time differences for synchronization with respect to the neighbor base stations.

Network Topology Advertisement

A serving base station transmits information related to network configuration to every MSS within a cell through a MAC management message (MOB-NBR-ADV) by a broadcasting method to report to the MSSs within the cell of the information about neighbor base stations.

MSS Scanning of Neighbor BS

A MSS must scan neighbor base stations for handover, and thus requests a serving base station for a scan duration for scanning neighbor base stations through a scan request message (MOB-SCN-REQ). The serving base station transmits a scanning response message (MOB-SCN-RSP) in response to the request message to allocate a duration during which the MSS scans for neighbor base stations. Moreover, the serving base station may directly transmit a scanning response message (MOB-SCN-RSP) without a request by the MSS (unsolicited request). A scan duration allocated by the serving base station and an offset for starting scanning are all allocated in units of frames.

Association Procedure

An association procedure is a procedure for the purpose of reducing a delay time taken for handover, in which a MSS acquires and stores basic information required for communication with neighbor base stations by initial ranging (procedure in which the MSS acquires basic information for communication from the base stations) of the base stations, and then communication with a target base station, one of the neighbor base stations, during actual handover is set up through the stored information. When a new base station is selected by scanning neighbor base stations, the MSS performs an association procedure. In the association, the MSS transmits a RNG-REQ-MAC message and the base station transmits a RNG-RSP MAC message to the corresponding MSS, to set the uplink power offset and uplink timing offset of the MSS to proper values. The transmission (initial ranging operation) of a RNG-REQ/RSP message by the MSS and the base station is the most basic operation of the IEEE802.16 system. Besides, this operation is a basic operation for the MSS performing a network entry procedure.

Afterwards, the MSS performs many processing procedures for handover (cell selection, handover initiation, handover cancellation, termination with the serving BS, handover denial) based on channel quality information of neighbor base stations acquired in the handover preprocessing processes.

Cell Selection

Cell selection is an operation of changing a cell in order for a MSS to newly register to a base station capable of receiving a SINR (signal-to-noise ratio) having a superior signal to the SINR of a signal transmitted from the base station of the current cell before normally registering to a cell. During the cell selection, the base station does not know about the movement of the MSS because the MSS did not perform a registration procedure. FIG. 2 shows a cell selection operation of IEEE802.16e.

Handover Initiation Handover initiation can be performed by both base station BS and MSS MSS. That is, if the base station BS requests for handover, the base station transmits a MOB_BSHO-REQ MAC message, and if the MSS MSS requests for handover, the MSS transmits a MOB_BSHO-REQ MAC message. In a case where the MSS transmits a MOB_BSHO-REQ MAC message, the SINR of signals received from neighbor base stations is transmitted to the base station and thus a list information of candidate base stations (Candidate BSs) which can serve as a new serving base station (Target BS) during handover is transmitted to the current serving BS. The serving BS permits the handover of a MSS after confirming an ACK for handover of a specific MSS from neighbor base stations before receiving a MOB_MSSHO-REQ MAC message from the MSS or transmitting a MOB_BSHO-REQ MAC message. The MSS or serving BS having received the MOB_BSHO-REQ MAC message (or MOB_MSSHO-REQ MAC message) is transmitted to report to a new serving base station (Target Bs) for performing handover.

Handover Cancellation

After a MSS or base station transmits a MOB_BSHO-REQ MAC message (or MOB_MSSHO-REQ MAC message) in order to perform handover, the MSS can cancel the handover. At this time, the MSS stops the handover currently in progress by setting a specific field of a MOB_HO-IND MAC message (HO_Type=01) and transmitting it to the base station.

Termination with the Serving BS

A MSS reports that handover is normally completed by transmitting a MOB_HO-IND MAC message to a serving BS, and then finishes the handover operation. At this time, the MSS transmits to the serving BS the information that the handover is normally terminated by setting a specific field of the MOB_HO-IND MAC message (HO_Type=00). The serving BS terminates all connections associated with data transmission including a MAC state machine, ARQ connection, etc. allocated to the MSS that is handed over upon receipt of the MOB_HO-IND MAC message from the MSS.

Handover Denial

A MSS may reject a handover that a serving BS recommends. At this time, the MSS sets a specific field of a MOB_HO-IND MAC message (HO_Type=10) and transmits it to the serving BS. When a reject message is received from the MSS, the serving BS reconfigures a new serving BS and retransmits a MOB_BSHO RSP message to the MSS.

FIG. 3 is a signal flow chart of a conventional neighbor base station scanning procedure.

Referring to FIG. 3, the procedure of MSS scanning of neighbor base station will be described in more detail.

First, a serving base station BS1 connected to a mobile subscriber station broadcasts information about neighbor base stations BS2 and BS3 to every MSS within its area. This information is transmitted through a MOB-NBR-ADV message. The format of the MOB-NBR-ADV message is as shown in Table 1. The MOB-NBR-ADV message contains the number of neighbor base stations, the identifiers of neighbor base stations, the frequencies of neighbor base stations, the channel information of neighbor base stations, etc.

The mobile subscriber station that periodically receives the MOB-NBR-ADV message temporally stops data reception only when necessary, and transmits a MOB-SCN-REQ message to the serving base station BS1 for the purpose of obtaining a channel quality measurement time from the neighbor base stations BS2 and BS3. The format of the MOB-SCN-REQ message is as shown in Table 2.

During the measurement of the channel quality of the neighbor base stations BS2 and BS3, the serving base station BS1 stops the transmission of data to the mobile subscriber station and stores data, and then can transmit data after a scanning time requested by the mobile subscriber station. The serving base station BS1 transmits a MOB-SCN-RSP message to the corresponding mobile subscriber station in response to the MOB-SCN-REQ message. The format of the MOB-SCN-RSP message is as shown in Table 3.

The scanning interval (or scan duration) requested by the mobile subscriber station is guaranteed, and a promise that the guaranteed interval starts after a predetermined time (start frame) is made between the mobile subscriber station and the serving base station BS1. If the serving base station BS1 intends to reject a scan request from the mobile subscriber station, the scan duration field of the MOB-SCN-RSP message is set to 0 and transmitted to the mobile subscriber station.

TABLE 1

| Syntax | Size | Notes |
|---|---|---|
| MOB-NBR-ADV_Message_Format( ){ | | |
| Management Message Type = 53 | 8 bits | |
| Operation ID | 24 bits | Unique ID assigned to the |
| | | operation |
| Configuration Change Count | 8 bit | Incremented each time the |
| | | information for the associated |
| | | neighbor BS has changed |
| N_NEIGHBORS | 8 bits | |
| for (j=0; j< N_NEIGHBORS; j++) | | |
| { | | |
| Length | 8 bits | Length of message |
| | | information within the |
| | | iteration of N_NEIGHBOR in |
| | | bytes |
| Neighbor BS-ID | 24 bits | The least significant 24bits of |
| | | the Base Station ID |
| | | parameter in the DL-MAP |
| | | message of Neighbor BS. |
| Preamble Index | 8 bits | The index for the PHY profile |
| | | specific preamble Index is |
| | | PHY specific for SCa and |
| | | OFDMA. The value of |
| | | preamble Index shall be |
| | | ignored and a value of ‘Ox00’ |
| | | shall be used for OFDM PHY |
| PHY Profile ID | 16 bits | TBD |
| HO Process Optimization | 8 bits | |
| DCD Configuration Change | 8 bits | This represents the Neighbor |
| Count | | BS current DCD configuration |
| | | change count |
| UCD Configuration Change | 8 bits | This represents the Neighbor |
| Count | | BS current UCD configuration |
| | | change count |
| TLV Encoded Neighbor | Variable | TLV specific |
| information | | |
| } | | |
| } | | |

TABLE 2

| Syntax | Size | | Notes |
|---|---|---|---|
| MOB-SCN- | | | |
| REQ_Message_Format( ){ | | | |
| Management Message Type = | 8 | bits | |
| 50 | | | |
| Scan Duration | 8 | bits | Units are frames |
| Scan type | 1 | bit | [0] Scanning |
| | | | [1] Association |
| Reserved | 3 | bits | |
| If (Scan type = 0) { | | | |
| Interleaving interval | 8 | bits | Units are frames |
| Scan Iteration | 8 | bits | |
| } | | | |
| Else { | | | |
| For(j=0; | | | N_Recommended_BS |
| j<N_Recommended_BS; j++) { | | | can be derived from the |
| | | | known length of |
| | | | the MAC message |
| Association Test BS ID | 48 | bits | BS IDs of Available BS |
| | | | for Association |
| } | | | |
| ) | | | |
| HMAC Tuple | 21 | bytes | |
| } | | | |

TABLE 3

| Syntax | Size | | Notes |
|---|---|---|---|
| MOB-SCN- | | | |
| RSP_Message_Format( ){ | | | |
| Management Message Type = | 8 | bits | |
| 50 | | | |
| Scan Duration | 8 | bits | Units are frames |
| Start Frame | 4 | bits | |
| Scan type | 1 | bit | [0] Scanning |
| | | | [1] Association |
| If (Scan type = 0) { | | | |
| Interleaving interval | 8 | bits | Duration in frames |
| Scan iteration | 8 | bits | |
| Report mode | 2 | bits | 0b00: no report |
| | | | 0b01: periodic report |
| | | | 0b10: event triggered report |
| | | | 0b11: reserved |
| Scan report period | 8 | bits | Available only when the |
| | | | value of Report mode is set |
| | | | to 0b01. Scan report |
| | | | period in frames |
| Reserved | 3 | bits | Shall be set to zero. |
| } | | | |
| Else { | | | |
| Reserved | 7 | bits | |
| For(j=0; | | | N_Recommended_BS can |
| j<N_Recommended_BS; j++) { | | | be derived from the known |
| | | | length of the MAC |
| | | | message |
| Association Test BS ID | 48 | bits | BS IDs of Available BS for |
| | | | Association |
| } | | | |
| ) | | | |
| HMAC Tuple | 21 | bytes | See 11.1.2 |
| } | | | |

As shown in FIG. 3, the mobile subscriber station scans the channel quality of neighbor base stations BS2 and BS3 during a scan duration (N of Table 1) after a start frame (M of Table 1) time.

FIG. 3 shows a case in which scanning is performed once.

FIG. 4 is a view showing a procedure of performing periodic scanning by setting up Scan Iteration and Interleaving Interval in a MOB-SCN-REQ/RSP message.

The mobile subscriber station is able to make a plurality of periodical scan requests through the Scan Iteration and Interleaving Interval of the MOB-SCN-REQ message. The serving base station BS1 having received the plurality of scan requests sets up Scan Iteration and Interleaving Interval in the MOB-SCN-RSP message and transmit them to the mobile subscriber station, thereby enabling the mobile subscriber station to perform periodic scanning. If the mobile subscriber station intends to stop scanning during a scan duration and return to a normal operation state, Scan Duration, Interleaving Interval and Scan Iteration of MOB-SCN-REQ are set to 0 and transmitted to the serving base station BS1. If the serving base station BS1 intends to stop the scanning operation of the mobile subscriber station, Scan Duration, Interleaving Interval and Scan Iteration of MOB-SCN-RSP are set to 0 and transmitted to the mobile subscriber station.

Moreover, the mobile subscriber station may request an association with a specific neighbor base station through a MOB-SCN-REQ message. In this case, an association can be requested to the serving base station by setting Scan Duration and Start Frame.

The following is an explanation of periodic ranging.

Ranging consists of two procedures: initial ranging and periodic ranging. Initial ranging refers to a procedure allowing a mobile subscribe station acquire correct transmission parameters, such as time offset and Tx power level, so that the mobile subscriber station can uplink communicate with a base station in a network in a network registration procedure of the mobile subscriber station. Following initial ranging, the mobile subscriber station performs periodic ranging so that the mobile subscriber station can maintain uplink communications with the base station. In a broadband wireless access system, initial ranging is performed in all physical layers, however, it is somewhat different in a single carrier type or OFDM type.

For each mobile subscriber station, the serving base station shall maintain a T27 timer. At each expiration of the T27 timer, the serving base station allocates an uplink slot to the corresponding mobile subscriber station so as to perform ranging. FIG. 5 is a view showing the serving base station allocating an uplink slot to the mobile subscriber station for periodic ranging.

Meanwhile, the mobile subscriber station maintains a T4 timer. If the mobile subscriber station is not allocated with an uplink slot for data transmission from the serving base station until the expiration of the T4 timer, the mobile subscriber station determines that its uplink transmission parameters are no longer usable, the mobile subscriber station initiates MAC to restart initial ranging.

Once an uplink slot for periodic ranging is allocated to the mobile subscriber station, the serving base station monitors an uplink signal from the mobile subscriber station. If no ranging request message is received from the mobile subscriber station even though a predetermined number of uplink slots is allocated, the serving base station terminates management of connection with the corresponding mobile subscriber station.

The serving base station receives uplink signals containing a ranging request message from the mobile subscriber station, and measures the signal quality of these uplink signals. If the measured signal quality is higher than a reference value, it is reported through a ranging response message that the ranging has succeeded.

However, if the measured signal quality is less than a reference value, it is reported through a ranging response message along with a parameter correction value that ranging should be continued. If the signal quality of the uplink signals does not satisfy a reference value until a predetermined number of times of correction is exceeded, the serving base station reports to the mobile subscriber station to stop the ranging through a ranging response message, and terminates management of connection with the corresponding mobile subscriber station.

When the ranging response message is received, the mobile subscriber station corrects an uplink transmission parameter, and determines whether to terminate the ranging, or to continue the ranging or to initiate MAC and restart ranging.

Except, in an OFDMA system having a physical layer in a broadband wireless access system, the method for a mobile subscriber station performing periodic ranging is different from the method suggested above. In an OFDMA system, not the serving base station but the mobile subscriber station maintains a timer for controlling periodic ranging. When the timer T4 is expired, the mobile subscriber station sends a ranging code to the serving base station through a competition-based uplink slot, and the serving base station sends an uplink transmission parameter correction value to the corresponding mobile subscriber station through a ranging message. Accordingly, in the OFDMA system, no unicast uplink slot for periodic ranging is not allocated to a specific mobile subscriber station.

Problems of the conventional art as set forth are as follows.

In a broadband wireless access system, the mobile subscriber station must perform ranging periodically so as to maintain uplink communications with the serving base station, and for this purpose, the serving base station must allocate an uplink slot periodically to the mobile subscriber station. Further, the mobile subscriber station must perform scanning or association with neighbor base stations for handover. During these operations, data transmission and reception to/from the serving base station are impossible. Thus, in a case where a scan duration requested when the mobile subscriber station requests for scanning or association includes an uplink slot allocation time, point for periodic ranging, the serving base station can reject the scan request. Except, in a case where a scan request is denied in the conventional art, Scan Duration of a scanning response (MOB-SCN-RSP) message is set to 0 and reported to the mobile subscriber station.

In a case where the serving base station sets Scan Duration of the MOB-SCN-RSP message to 0 to reject a scan request from the mobile subscriber station as seen from above, the following two problems occur.

First, because the mobile subscriber station does not know the reason why the scan request is denied, it may request scanning of neighbor base stations again by sending a scan request message to the serving base station before performing periodic ranging. In this case, the serving base station must reject again the scan request from the mobile subscriber station through a scanning response message, and thus an unnecessary exchange of a MAC message occurs between the mobile subscriber station and the serving base station. Such an unnecessary MAC message exchange becomes one of the causes of the waste of wireless resources and deteriorates the MAC processing efficiency.

Second, when the serving base station intends to reject the scan request from the mobile subscriber station or stops the scanning of the mobile subscriber station during an Interleaving Interval of periodic scanning, a conventional scanning response message MOB-SCN-RSP has an inefficiency that all message parameters of about 5 bytes, including Scan Duration, Start Frame, Interleaving Interval, Scan iteration, Report Mode, Scan Period, etc. should be set to 0.

### BRIEF DESCRIPTION OF THE DRAWINGS

FIG. 1 is a view showing an IEEE802.16e network structure and a handover procedure;

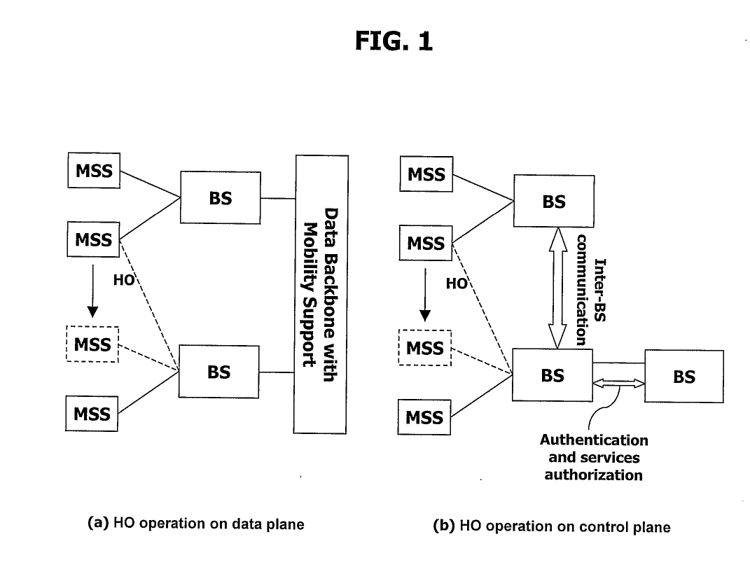

FIG. 2 is a view showing a cell selection operation of IEEE802.16e;

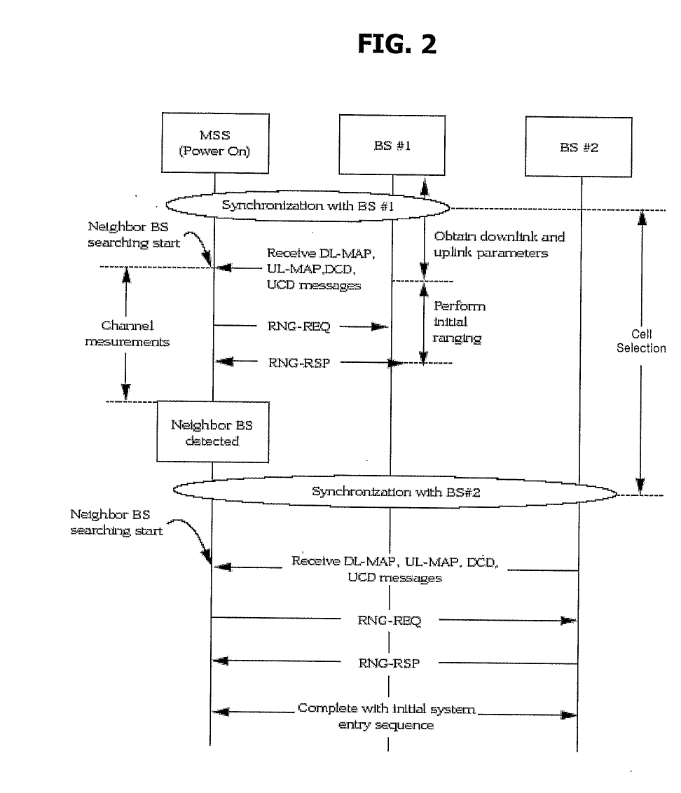

FIG. 3 is a signal flow chart of a conventional neighbor base station scanning procedure;

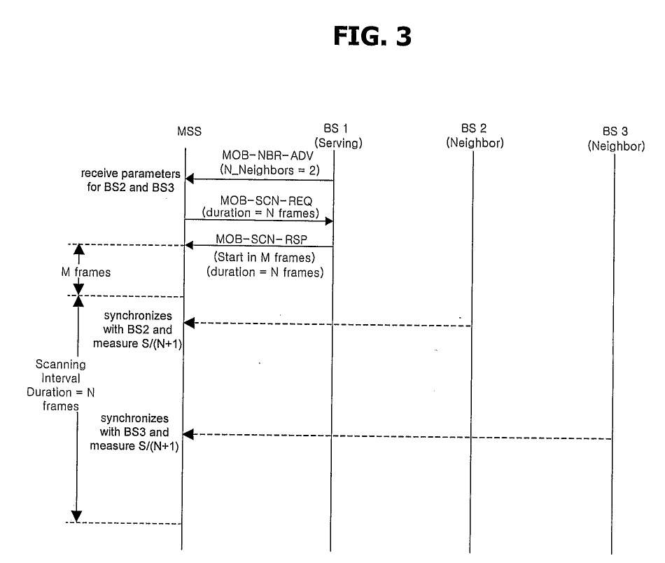

FIG. 4 is a view showing a periodical scanning procedure according to the prior art;

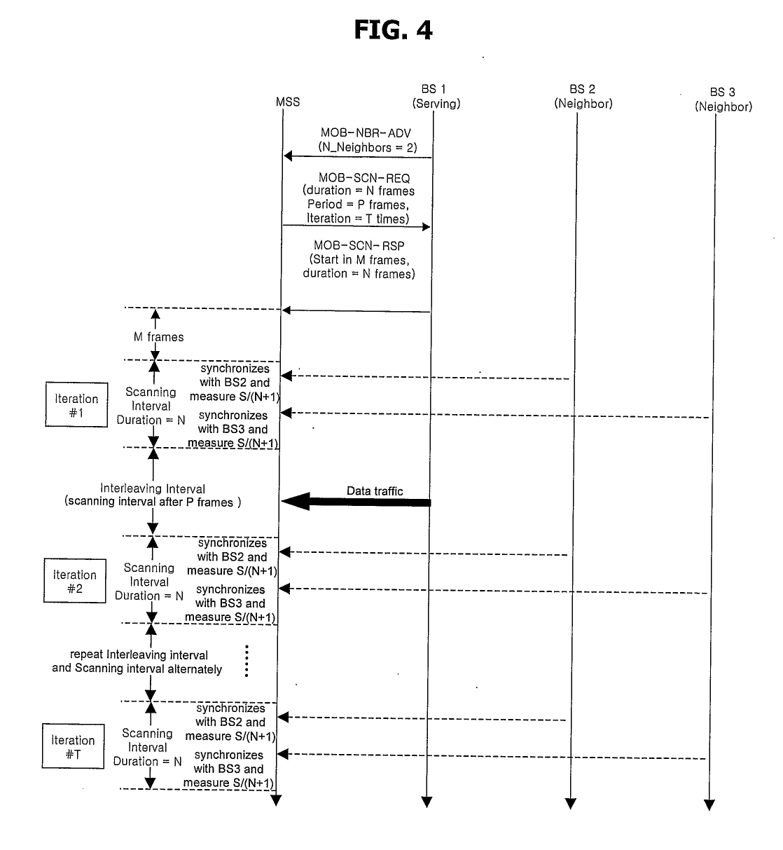

FIG. 5 is a view showing an uplink slot allocation of a serving base station for periodic ranging;

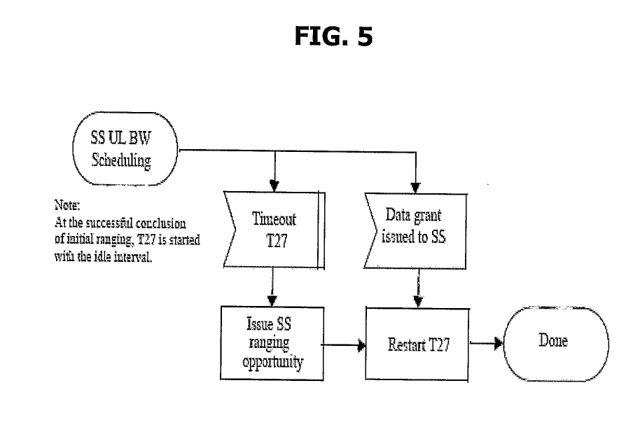

FIG. 6 is a signal flow chart of a scanning procedure according to a first embodiment of the present invention;

FIG. 7 is a signal flow chart of a scanning procedure according to a second embodiment of the present invention; and

FIG. 8 is a signal flow chart of a scanning procedure according to a third embodiment of the present invention.

### TECHNICAL PROBLEMS

The present invention is directed to solve the aforementioned problems, and has for its object to provide a method for base-station scanning of a mobile subscriber station which allows a periodic ranging procedure of the mobile subscriber station to be performed regardless of a scanning operation, and a method for optimizing a scanning response message by stopping a periodic ranging of the mobile subscriber station by a base station or reducing the size of the scanning response message denying a scan request.

### BEST MODE FOR EMBODYING THE INVENTION

To accomplish the above object, there is provided a method for base-station scanning of a mobile subscriber station if a periodic ranging time point and a scan duration are overlapped according to the present invention, comprising the steps of: requesting a base station for scanning; receiving a scanning denial response message from the base station; performing ranging with the base station when a ranging time comes; and requesting the base station for scanning again after the lapse of a predetermined time.

Preferably, the response message includes a flag or scan duration parameter set to 0 representing the permission or denial of scanning.

Preferably, the response message includes information on the predetermined time.

To accomplish the above object, there is provided a method for base-station scanning of a mobile subscriber station if a periodic ranging time point and a scan duration are overlapped according to the present invention, comprising the steps of: requesting a base station for scanning; receiving a scanning permission response message from the base station; performing ranging with the base station when a ranging time comes; and performing scanning of neighbor base stations when a scanning time comes.

To accomplish the above object, there is provided a method for base-station scanning of a mobile subscriber, station in a broadband wireless access system according to the present invention, comprising the steps of: requesting a base station for scanning; and receiving a flag representing the permission or denial of scanning or a scanning denial response message containing a scan duration parameter set to 0 from the base station.

To accomplish the above object, there is provided a method for base station association of a mobile subscriber station in a broadband wireless access system according to the present invention, comprising the steps of: requesting a base station for association; and receiving a flag representing the permission or denial of association or an association denial response message containing a scan duration parameter set to 0 from the base station.

To accomplish the above object, there is provided a method for base-station scanning of a mobile subscriber station if a periodic ranging time point and a scan duration are overlapped according to the present invention, comprising the steps of: performing base station scanning upon permission of the base station; receiving a flag representing the permission or denial of scanning or a scanning stop request message containing a scan duration parameter set to 0 from the base station; and stopping a scanning operation and performing ranging with the base station.

The present invention suggests the following three methods for optimizing a scanning response (MOB-SCN-RSP) message of a serving base station for a scan request from a mobile subscriber station.

First, the denial or approval of a scan request from a mobile subscriber station is represented by a 1-bit flag or a scan duration parameter set to 0. In case of approving the scan request from the mobile subscriber station, in the present invention, parameters associated with scanning defined in the prior art are included as they are in a scanning response message. However, in case of denying the scan request, the parameters associated with scanning are not included in the scanning response message. The flag or scan duration parameter set to 0 representing denial or approval is also applicable to an association procedure of a mobile subscriber station.

Second, in a system supporting a single carrier or OFDM physical layer, in a case where a periodic ranging time (T27 timeout) of a mobile subscriber station is included in the scan duration requested by the mobile subscriber station, a serving base station according to the present invention reports information on a scanning denial command and a periodic ranging duration to the mobile subscriber station through a scanning response message. Afterwards, when the periodic ranging is completed, the mobile subscriber station may request the serving base station for scanning again.

Third, in a case where the mobile subscriber station's scanning and periodic ranging time points are overlapped, the serving base station may control so that the scanning of the mobile subscriber station can be performed after the periodic ranging by setting the scanning start time after the ranging while approving a scan request.

Hereinafter, preferred embodiments of the present invention will be described with reference to the accompanying drawings.

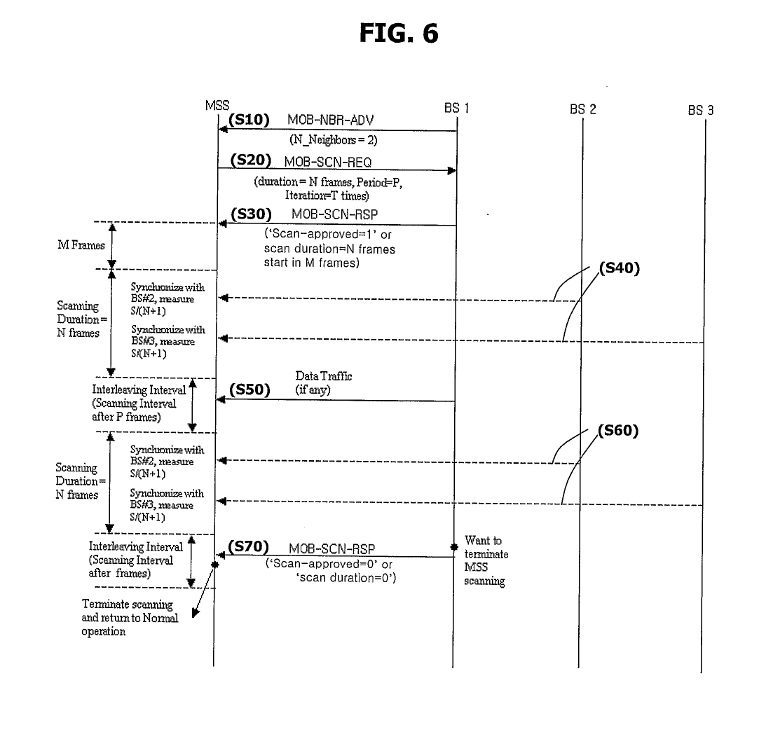

FIG. 6 is a signal flow chart of a scanning procedure according to a first embodiment of the present invention. The following Table 4-1 and Table 4-2 show resulting scan request messages. As shown in Table 4-1 and 4-2, the present invention greatly reduces the size of a scanning response message denying a scan request from a mobile subscriber station by including a flag (scan-approved) or scan duration parameter in a scanning response message.

TABLE 4-1

| Syntax | Size | Notes |
|---|---|---|
| MOB-SCN- | | |
| RSP_Message_Format( ){ | | |
| Management Message Type = | 8 bits | |
| 50 | | |
| Scan-approved | 1 bit | 0: Scan reauest denied |
| | | 1: Scan request approved |
| If (Scan-approved = 1) { | | |
| Scan Duration | 8 bits | Units are frames |
| Start Frame | 4 bits | |
| Scan type | 1 bit | [0] Scanning |
| | | [1] Association |
| If (Scan type = 0) { | | |
| Interleaving interval | 8 bits | Duration in frames |
| Scan iteration | 8 bits | |
| Report mode | 2 bits | 0b00 : no report |
| | | 0b01 : periodic report |
| | | 0b10 : event triggered report |
| | | 0b11 : reserved |
| Scan report period | 8 bits | Available only when the value |
| | | of Report mode is set to 0b01. |
| | | Scan report period in frames |
| Reserved | 2 bits | Shall be set to zero. |
| } | | |
| Else { | | |
| Reserved | 6 bits | |
| For(j=0; | | N_Recommended_BS can be |
| j<N_Recommended_BS; j++) { | | derived from the known |
| | | length of the MAC message |
| Association Test BS ID | 48 bits | BS IDs of Available BS for |
| | | Association |
| } | | |
| ) | | |
| } | | |
| Else { | | |
| Reserved | 7 bits | Shall be set to zero. |
| } | | |
| HMAC Tuple | 21 bytes | See 11.1.2 |
| } | | |

TABLE 4-2

| Syntax | | Size | Notes |
|---|---|---|---|
| MOB-SCN- | | | |
| RSP_Message_Format( ){ | | | |
| | Management Message Type = | 8 bits | |

| 50 | | | |
|---|---|---|---|
| | Scan Duration | 8 bits | Units are frames |
| | If (Scan Duration = 1) { | | |
| | Start Frame | 4 bits | |
| | Scan type | 1 bit | [0] Scanning |

[1] Association

If (Scan type = 0) {

| Interleaving interval | 8 bits | Duration in frames |
|---|---|---|
| Scan iteration | 8 bits | |
| Report mode | 2 bits | 0b00: no report |
| | | 0b01: periodic report |
| | | 0b10: event triggered report |
| | | 0b11: reserved |
| Scan report period | 8 bits | Available only when the value of |
| | | Report mode is set to 0b01. |
| | | Scan report period in frames |
| Reserved | 2 bits | Shall be set to zero. |

}
Else {

| | Reserved | 6 bits | |
|---|---|---|---|
| | For(j=0; | | N_Recommended_BS can be |
| j<N_Recommended_BS; j++) { | | | derived from the known length |
| | | | of the MAC message |
| | Association Test BS ID | 48 bits | BS IDs of Available BS for |

Association

}

)

}
Else {

| | | |
|---|---|---|
| Reserved | 7 bits | Shall be set to zero. |

| } | | |
|---|---|---|
| HMAC Tuple | 21 bytes | See 11.1.2 |

}

Referring to FIG. 6 and Table 4-1 and Table 4-2, a scanning procedure according to a first embodiment of the present invention will now be described.

Firstly, a serving base station BS1 connected to a mobile subscriber station broadcasts information on neighbor base stations BS2 and BS3 to all mobile subscriber stations within its area (S10). This information is transmitted in a MOB-NBR-ADV message.

The mobile subscriber station having periodically received the MOB-NBR-ADV message requests scanning of the neighbor base stations by transmitting a scan request message (MOB-SCN-REQ) message to the serving base station BS1 (S20). The mobile subscriber station may request for a periodic scanning according to the settings of Scan Iteration and Interleaving Interval of the scan request message.

The serving base station BS1 transmits a MOB-SCN-RSP message to the corresponding mobile subscriber station in response to the MOB-SCN-REQ message (S30). At this time, the serving base station BS1 reports to the mobile subscriber station whether to approve or deny scanning through the MOB-SCN-RSP message. In case of denying the scan request, the serving base station BS1 sets Scan-approved field to 0 and omits the other scan parameters (Scan duration, Start frame, Interleaving interval, Scan iteration, etc) (as in Table 4-1), or it sets scan duration to 0 and omits the other parameters (Start frame, Interleaving interval, Scan iteration, etc.) (as in Table 4-2), and then sends a scanning response message to the mobile subscriber station.

In contrast, in case of approving the scan request, the serving base station BS1 sets Scan-approved field to 1 and sets the other scan parameters (Scan duration, Start frame, Interleaving interval, Scan iteration, etc) (as in Table 4-1), or it sets scan duration to a value other than 0 and sets the other parameters (Start frame, Interleaving interval, Scan iteration, etc.) (as in Table 4-2), and then sends a scanning response message to the mobile subscriber station. When a scan start time comes, the mobile subscriber station approved to scan establishes downlink synchronization with the neighbor base stations BS2 and BS3 and measures the signal quality (S40).

When the scan duration is finished, the mobile subscriber station performing periodic scanning synchronizes with the serving base station BS1 and maintains communications with the serving base station BS1 during Interleaving interval (S50). When the Interleaving interval is finished, the mobile subscriber station establishes downlink synchronization with the neighbor base stations BS2 and BS3 and measures the signal quality (S60).

Afterwards, in case of intending to finish the periodic scanning of the mobile subscriber station, the serving base station BS1 sets Scan-approved field of the scanning response message to 0 or sets Scan duration to 0 during Interleaving interval, and transmits it to the mobile subscriber station. The mobile subscriber station having received this setting finishes the periodic scanning, returns to a normal operation state and performs communications with the serving base station BS1 (S70).

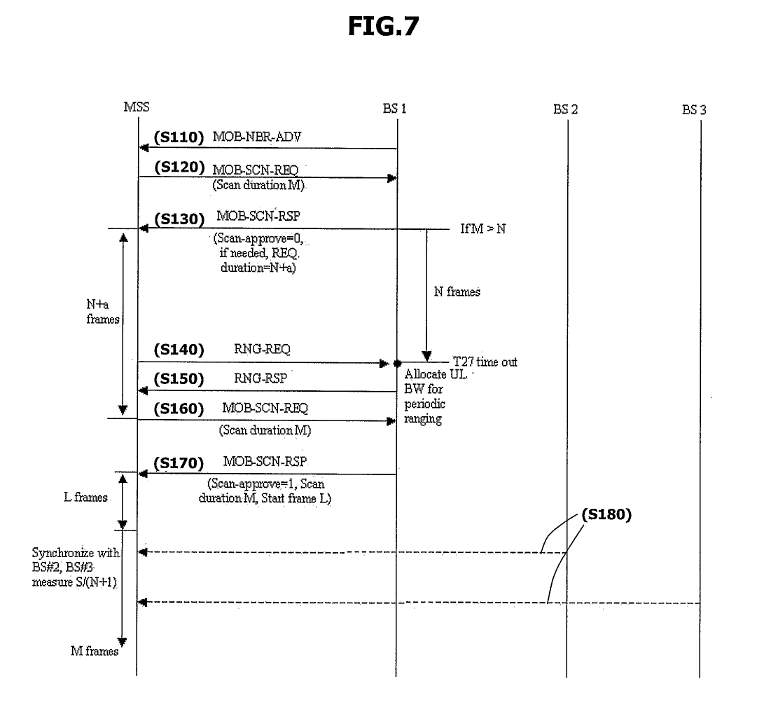

FIG. 7 is a signal flow chart of a scanning procedure according to a second embodiment of the present invention. The scanning response message of Table 5 includes information (REQ-duration) on the periodic ranging time as well as a flag or scan duration parameter (Scan-approved) set to 0.

The mobile subscriber station according to the second embodiment of the present invention performs a scan request again after the duration (REQ-duration) set by the serving base station.

TABLE 5

| Syntax | Size | | Notes |
|---|---|---|---|
| MOB-SCN- | | | |
| RSP_Message_Format( ){ | | | |
| Management Message Type = | 8 | bits | |
| 50 | | | |
| Scan-approved | 1 | bit | 0: Scan request denied |
| | | | 1: Scan request approved |
| If (Scan-approved = 1) { | | | |
| Scan Duration | 8 | bits | Units are frames |
| Start Frame | 4 | bits | |
| Scan type | 1 | bit | [0] Scanning |
| | | | [1] Association |
| If (Scan type = 0) { | | | |
| Interleaving interval | 8 | bits | Duration in frames |
| Scan iteration | 8 | bits | |
| Report mode | 2 | bits | 0b00: no report |
| | | | 0b01: periodic report |
| | | | 0b10: event triggered report |
| | | | 0b11: reserved |
| Scan report period | 8 | bits | Available only when the |
| | | | value of Report mode is set |
| | | | to 0b01. Scan report period |
| | | | in frames |
| Reserved | 2 | bits | Shall be set to zero. |
| } | | | |
| Else { | | | |
| Reserved | 6 | bits | |
| For(j=0; | | | N_Recommended_BS can |
| j<N_Recommended_BS; j++) { | | | be derived from the |
| | | | known length of the MAC |
| | | | message |
| Association Test BS ID | 48 | bits | BS IDs of Available BS for |
| | | | Association |
| } | | | |
| ) | | | |
| } | | | |
| Else { | | | |
| Reserved | 7 | bits | Shall be set to zero. |
| TLV encoded value | 24 | bits | This TLV parameter is |
| | | | REQ-duration, which is |
| | | | time duration until Scan |
| | | | Request may be retried |
| | | | (in frames) in case of Scan |
| | | | request denied. This |
| | | | value may be included |
| | | | only in SCa, OFDM PHY. |
| } | | | |
| HMAC Tuple | 21 | bytes | See 11.1.2 |
| } | | | |

The following Table 6 shows an example of a TLV value which may be included in a scanning response (MOB-SCN-RSP) message.

TABLE 6

| Name | Type | Length | Value |
|---|---|---|---|
| REQ-duration | TBD | 1 Byte | Number of frames until Scan Request |
| | | | may be retried |

Referring to FIG. 7 and Table 5, a scanning procedure according to a second embodiment of the present invention will be described.

Firstly, a serving base station BS1 connected to a mobile subscriber station broadcasts information on neighbor base stations BS2 and BS3 to all mobile subscriber stations within its area (S110). This information is transmitted in a MOB-NBR-ADV message.

The mobile subscriber station having periodically received the MOB-NBR-ADV message requests scanning of the neighbor base stations by transmitting a scan request message (MOB-SCN-REQ) message to the serving base station BS1 (S120).

The serving base station BS1 transmits a MOB-SCN-RSP message to the corresponding mobile subscriber station in response to the MOB-SCN-REQ message (S130). At this time, the serving base station BS1 reports to the mobile subscriber station whether to approve or deny scanning through the MOB-SCN-RSP message. If the periodic ranging time point of the mobile subscriber station is included in Scan duration requested by the mobile subscriber station, Scan-approved field of the scanning response message is set to 0, and REQ-duration field is set so that the mobile subscriber station can perform periodic ranging and transmitted to the serving base station.

The mobile subscriber station having received the scan request message in which the REQ-duration is set requests for scanning again after REQ-duration, and after the REQ-duration, the mobile subscriber station determines whether to request scanning again.

When a periodic ranging time comes, the mobile subscriber station having received the scan request message transmits a ranging request message to the serving base station BS1 by using an uplink slot allocated from the serving base station BS1 (S140).

The serving base station BS1 having received the ranging request message from the mobile subscriber station allows the mobile subscriber station to maintain uplink communications by transmitting an uplink transmission parameter correction value to the mobile subscriber station through the ranging request message (S150).

Afterwards, after the REQ-duration, the mobile subscriber station requests for scanning of neighbor base stations again by transmitting a scan request message to the serving base station BS1 (S160). The serving base station BS1 approves scanning by setting Scan-approved field of a scan response message to 1, and setting Scan parameter and transmitting it to the mobile subscriber station (S170).

When a scan start time comes, the mobile subscriber station approved to scan establishes downlink synchronization with the neighbor base stations BS2 and BS3 and measures the signal quality (S180). In a case where the mobile subscriber station requests for periodic scanning, if a periodic ranging time of the mobile subscriber station is included during second or subsequent Scan duration, the serving base station BS1 sets Scan-approved field of a scan request message to 0 and transmits it to the mobile subscriber station so as to terminate the periodic ranging whenever and perform a periodic ranging using the uplink slot allocated by the serving base station BS1.

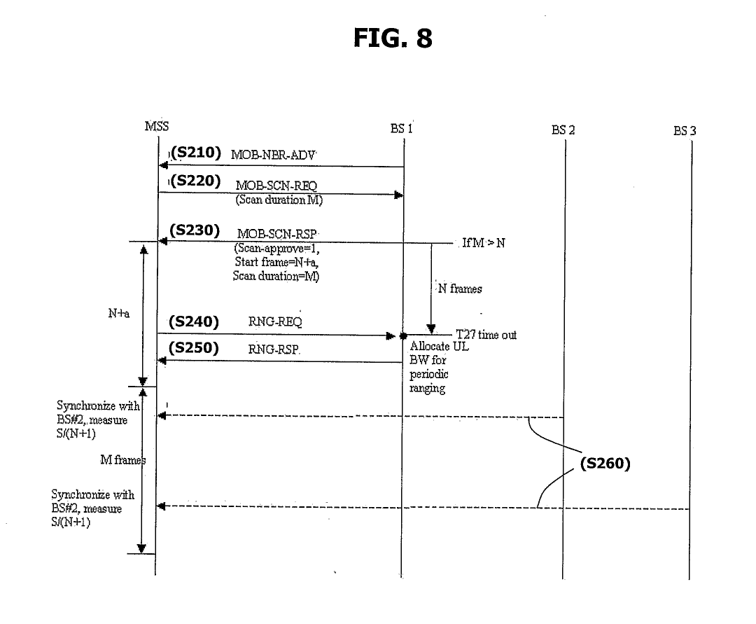

FIG. 8 is a signal flow chart of a scanning procedure according to a third embodiment of the present invention. The following Table 7 shows a resulting scan 15 request message. The scan request message of Table 7 includes a flag or scan duration parameter (Scan-approved) set to 0, and has such a Start frame value that is set to perform scanning of the mobile subscriber station after periodic ranging.

TABLE 7

| Syntax | Size | | Notes |
|---|---|---|---|
| MOB-SCN- | | | |
| RSP_Message_Format( ){ | | | |
| Management Message Type = | 8 | bits | |
| 50 | | | |
| Scan-approved | 1 | bit | 0: Scan request denied |
| | | | 1: Scan request approved |
| IF (Scan-approved = 1) { | | | |
| Scan Duration | 8 | bits | Units are frames |
| Start Frame | 8 | bits | |
| Scan type | 1 | bit | [0] Scanning |
| | | | [1] Association |
| If (Scan type = 0) { | | | |
| Interleaving interval | 8 | bits | Duration in frames |
| Scan iteration | 8 | bits | |
| Report mode | 2 | bits | 0b00: no report |
| | | | 0b01: periodic report |
| | | | 0b10: event triggered report |
| | | | 0b11: reserved |
| Scan report period | 8 | bits | Available only when the |
| | | | value of Report mode is set |
| | | | to 0b01. Scan report period |
| | | | in frames |
| Reserved | 4 | bits | Shall be set to zero. |
| } | | | |
| Else { | | | |
| Reserved | 6 | bits | |
| For(j=0; | | | N_Recommended_BS can |
| j<N_Recommended_BS; j++) { | | | be derived from the known |
| | | | length of the MAC message |
| Association Test BS ID | 48 | bits | BS IDs of Available BS for |
| | | | Association |
| } | | | |
| ) | | | |
| } | | | |
| Else { | | | |
| Reserved | 7 | bits | Shall be set to zero. |
| } | | | |
| HMAC Tuple | 21 | bytes | See 11.1.2 |
| } | | | |

In the third embodiment of the present invention, since a scan start time point has to be adjusted by Start frame, the size of Start frame field has to be modified to be the same or larger than Scan duration. Further, the serving base station may deny a scan request from the mobile subscriber station or stop periodic scanning being performed by the mobile subscriber station by setting Scan-approved of a scan request message to 0.

Referring to FIG. 8 and Table 7, a scanning procedure according to a third embodiment of the present invention will be described.

Firstly, a serving base station BS1 connected to a mobile subscriber station broadcasts information on neighbor base stations BS2 and BS3 to all mobile subscriber stations within its area (S210). This information is transmitted in a MOB-NBR-ADV message.

The mobile subscriber station having periodically received the MOB-NBR-ADV message requests scanning of the neighbor base stations by transmitting a scan request message (MOB-SCN-REQ) message to the serving base station BS1 (S220).

The serving base station BS1 transmits a MOB-SCN-RSP message to the corresponding mobile subscriber station in response to the MOB-SCN-REQ message (S230). At this time, the serving base station BS1 reports to the mobile subscriber station whether to approve or deny scanning through the MOB-SCN-RSP message. If the periodic ranging time point of the mobile subscriber station is included in Scan duration requested by the mobile subscriber station, the serving base station BS1 sets Start frame of the scan request message to after a ranging time point and sets Scan-approved field of the scan request message to 1, and transmit them to the mobile subscriber station. Except, in this case, the size of Start frame field has to be larger or same as Scan duration field because Start frame must indicate whether a periodic ranging time point is included in Scan duration.

When a periodic ranging time comes, the mobile subscriber station having received the scan request message transmits a ranging request message to the serving base station BS1 by using an uplink slot allocated from the serving base station BS1 (S240).

The serving base station BS1 having received the ranging request message from the mobile subscriber station allows the mobile subscriber station to maintain uplink communications by transmitting an uplink transmission parameter correction value to the mobile subscriber station through the ranging request message (S250). Afterwards, when Start frame comes, the mobile subscriber station establishes downlink synchronization with neighbor base stations and measures the signal quality (S260).

In a case where the mobile subscriber station requests for periodic scanning, if a periodic ranging time of the mobile subscriber station is included during second or subsequent Scan duration, the serving base station BS1 sets Scan-approved field of a scan request message to 0 and transmits it to the mobile subscriber station so as to terminate the periodic ranging whenever and perform a periodic ranging using the uplink slot allocated by the serving base station BS1.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

As described above, in a case where the serving base station denies a scan request from the mobile subscriber station, it is possible to reduce the size of a scan request message and saving wireless resources by using a 1-bit flag or scan duration parameter set to 0 representing the approval or denial of scanning instead of setting all scan parameters of a scan request message to 0.

Moreover, when the mobile subscriber station requests for a base station scanning, if a scan duration includes a time point for performing periodic ranging of the mobile subscriber station, the present invention has the effect of avoiding a periodic ranging operation of a mobile subscriber station from being obstructed by a scanning operation by allowing the mobile subscriber station to request for scanning again through a scan request message after performing a periodic ranging or to perform scanning.

1. A method for base-station scanning of a mobile subscriber station if a periodic ranging time point and a scan duration are overlapped, comprising the steps of:
requesting a base station for scanning;
receiving a scanning denial response message from the base station;
performing ranging with the base station when a ranging time comes; and
requesting the base station for scanning again after the lapse of a predetermined time.

2. The method of claim 1, wherein the response message includes a flag representing the permission or denial of scanning.

3. The method of claim 1, wherein the response message includes a scan duration parameter set to 0 representing the permission or denial of scanning.

4. The method of claim 1, wherein the response message includes information on the predetermined time.

5. A method for base-station scanning of a mobile subscriber station if a periodic ranging time point and a scan duration are overlapped, comprising the steps of:
requesting a base station for scanning;
receiving a scanning permission response message from the base station;
performing ranging with the base station when a ranging time comes; and
performing scanning of neighbor base stations when a scanning time comes.

6. The method of claim 5, wherein the response message includes a flag representing the permission or denial of scanning.

7. The method of claim 5, wherein the response message includes a scan duration parameter set to 0 representing the permission or denial of scanning.

8. The method of claim 5, wherein the response message includes information on the scanning time.

9. The method of claim 5, wherein the scanning time is set after the ranging time.

10. A method for base-station scanning of a mobile subscriber station in a broadband wireless access system, comprising the steps of:
requesting a base station for scanning; and
receiving a flag representing the permission or denial of scanning or a scanning denial response message containing a scan duration parameter set to 0 from the base station.

11. The method of claim 10, wherein the response message includes a scan duration parameter set to 0 representing the permission or denial of scanning.

12. A method for base station association of a mobile subscriber station in a broadband wireless access system, comprising the steps of:
requesting a base station for association; and
receiving a flag representing the permission or denial of association or an association denial response message containing a scan duration parameter set to 0 from the base station.

13. The method of claim 12, wherein the response message includes a scan duration parameter set to 0 representing the permission or denial of scanning.

14. A method for base-station scanning of a mobile subscriber station if a periodic ranging time point and a scan duration are overlapped comprising the steps of:
performing base station scanning upon permission of the base station;
receiving a flag representing the permission or denial of scanning or a scanning stop request message containing a scan duration parameter set to 0 from the base station; and
stopping a scanning operation and performing ranging with the base station.
